(19) United States
(12) Patent Application Publication
(10) Pub. No.: US 2003/0005902 A1
(43) Pub. Date: Jan. 9, 2003

(54) Four-stroke internal combustion engine cylinder head

(76) Inventors: Takaaki Tsukui, Saitama (JP); Hiromi Sumi, Saitama (JP)

Correspondence Address: BIRCH STEWART KOLASCH & BIRCH, PO BOX 747, FALLS CHURCH, VA, 22040-0747, US

(21) Appl. No.: 10/162,875

(22) Filed: Jun. 6, 2002

(30) Foreign Application Priority Data
Jul. 6, 2001 (JP) 2001-205706

(51) Int. Cl. F02N 3/00

(52) U.S. Cl. 123/188.9

(57) ABSTRACT

A cylinder head in which any valve guide can be press-fitted in the cylinder head with a substantially uniform press fit force based upon the cylinder head in which at least one valve guide out of a plurality of valve guides for respectively guiding intake and exhaust poppet valves of an OHC four-stroke internal combustion engine are provided with valve lifters so that the valve guide can slide in a direction in which each valve that is opened or closed is fitted differently in the depth of a fitted part. A cylinder head of a four-stroke internal combustion engine is provided wherein a plurality of valve guides for guiding and supporting intake and exhaust poppet valves so that they can slide in a direction in which they are opened or closed have a substantially uniform thickness in the respective longitudinal directions of the valve guides and depth in which at least one valve guide out of the plurality of valve guides is fitted in the cylinder head and is different from a depth in which another valve guide is fitted in the cylinder head. An idle fitting hole thicker than the valve guide is formed in a depth H acquired by subtracting the depth H₂ of the shallower fitted part from the depth H₁ of the deeper fitted part from each end face of fitted parts on the sides of valve springs and toward an inlet port.

### BACKGROUND OF THE INVENTION

### CROSS-REFERENCE TO RELATED APPLICATIONS

The present application claims priority under 35 USC 119 to Japanese Patent Application No. 2001-205706 filed on Jul. 6, 2001 the entire contents thereof is hereby incorporated by reference.

1. Field of the Invention

The present invention relates to a cylinder head in which at least one of a plurality of valve guides for guiding intake and exhaust poppet valves in an opened or closed direction so that they can have a slide fit of a different depth in an overhead camshaft (OHC) four-stroke internal combustion engine that is provided with a valve lifter. More particularly, to a cylinder head of a four-stroke internal combustion engine in which a valve pause mechanism is provided to an intake poppet valve or an exhaust poppet valve fitted into a shallow valve guide in the depth of a fitted part.

2. Description of Background Art

As shown in FIG. 13, in an OHC four-stroke internal combustion engine provided with a valve lifter 00, the positions X₁, X₂ at the respective lower ends of valve lifter springs 03, 04 always press intake and exhaust poppet valves 01, 02 in a closed direction and are different between the position of the valve lifter provided with a valve pause mechanism 05 and the position of the valve lifter without the valve pause mechanism 05. The valve lifter spring 03 is provided to the intake or exhaust poppet valve 01 and is provided with the valve pause mechanism 05 that is positioned to be lower by the quantity of the valve pause mechanism 05 attached to the valve lifter 00 of the intake or exhaust poppet valve 01. A valve guide 06 is provided for guiding the intake or exhaust poppet valve 01 so that it can slide is a shorter distance as compared with a valve guide 07 on the side provided with no valve pause mechanism 05. For example, refer to Japanese Published Unexamined Patent Application No. 2000-205038.

Therefore, the longer valve guide 07 for guiding the intake or exhaust poppet valve 02 is provided with no valve pause mechanism 05 so that it can slide and is required to be press-fitted into a fitting hole 09 to be deeper in a cylinder head 08 by longer quantity. The press fitting resistance is remarkably larger as compared with the press fitting resistance in which the valve guide 06 of the intake or exhaust poppet valve 01 that is provided with the valve pause mechanism 05 that is press-fitted and the press fit depth is deeper. As a result, the setting of the press fit time of each valve guide 06, 07 is different and the management of the manufacturing process is complex and is not easy.

### SUMMARY AND OBJECTS OF THE INVENTION

The invention relates to an improvement of a cylinder head of a four-stroke internal combustion engine in which such a problem is solved. The present invention is based upon a cylinder head of a four-stroke internal combustion engine in which plural valve guides for guiding and supporting intake and exhaust poppet valves in an opened or closed direction so that they can slide and have substantially a uniform thickness in the longitudinal direction of the valve guide. A depth of at least one of the plurality of valve guides fitted in the cylinder head is different from the depth of the other valve guide that is fitted in the cylinder head. An idle fitting hole having a depth that is acquired by subtracting the depth that is substantially equal to the depth of the shallower fitted part from the depth of the deeper fitted part and thicker than the valve guide is formed from the end face of a fitted part on the side of a valve spring toward an inlet port or an exhaust port in the cylinder head.

The present invention is configured as described above with all the valve guides press-fitted at a uniform press fit depth in the cylinder head independent of the length of a specific valve guide even if the specific valve guide out of the plurality of valve guides is long.

Therefore, the setting of the press fit time is simplified and the press fitting force required to press-fit is also unified. The control required to press-fit is facilitated and the quality of press fitting is stabilized and the productivity is enhanced.

Also, a long valve guide for guiding an intake or exhaust poppet valve provided with no valve pause mechanism so that it can slide can be press-fitted with the same strength, in the same length, therefore, in the same required time as the press fitting of a short valve guide for guiding an intake or exhaust poppet valve provided with a valve pause mechanism according to the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view showing a four-stroke internal combustion engine with a valve pause mechanism according to the invention;

FIG. 2 is a top view showing a front cylinder head from which a front head cover is detached;

FIG. 3 is a longitudinal side view viewed along a line III-III in FIG. 2;

FIG. 4 is a longitudinal side view showing a state in which the pause of a valve is released in FIG. 3;

FIG. 5 is a longitudinal side view showing a state in which the pause of the valve is released and an exhaust valve is opened by a cam in FIG. 3;

FIG. 6 is an explanatory drawing showing a state in which cylinder holes and intake and exhaust poppet valves are arranged;

FIG. 7 is a perspective view showing a slide pin holder;

FIG. 8 is a perspective view showing a slide pin;

FIG. 9 is a longitudinal side view showing an enlarged main part showing a valve pause state of a valve lifter with a valve pause mechanism;

FIG. 10 is a longitudinal side view showing an enlarged main part showing a valve pause released state of a valve lifter with a valve pause mechanism;

FIG. 11 is a sectional view viewed along a line XI-XI in FIG. 9;

FIG. 12 is a longitudinal side view in which the main part shown in FIG. 3 is enlarged; and

FIG. 13 is a longitudinal sectional view showing the main part of a cylinder head of a conventional type four-stroke internal combustion engine with a valve pause mechanism.

### DETAILED DESCRIPTION OF THE PREFERRED EMBODIMENTS

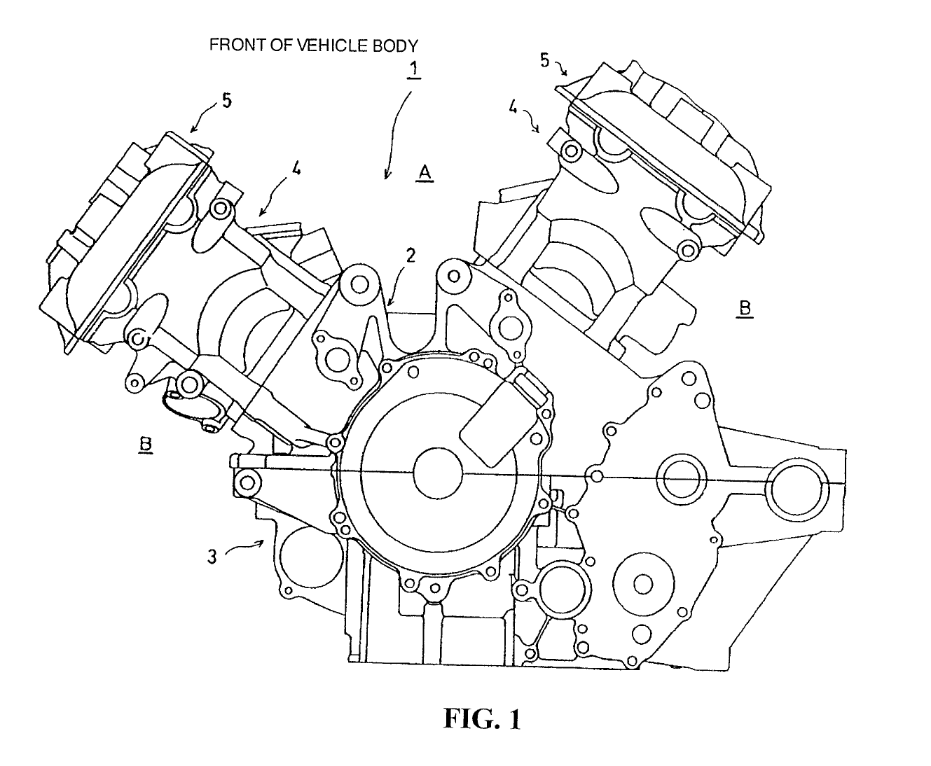

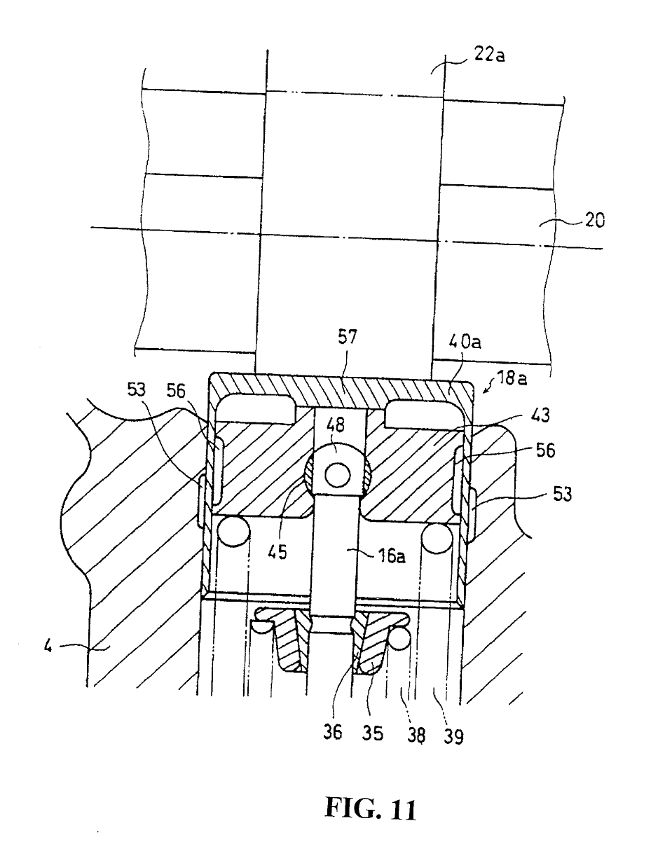

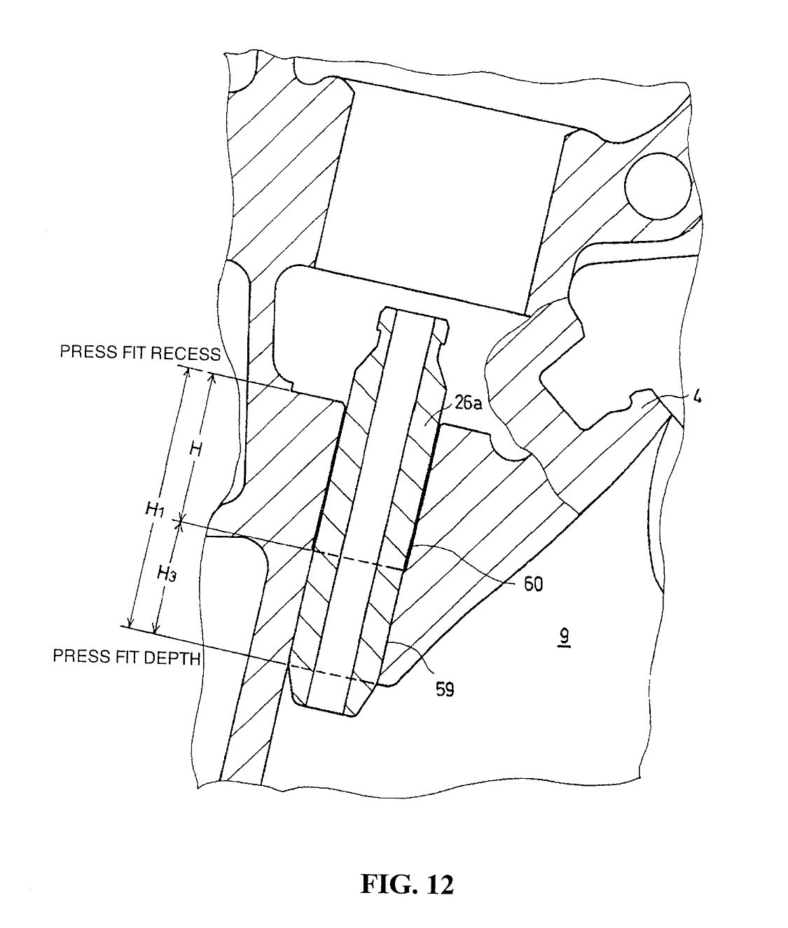

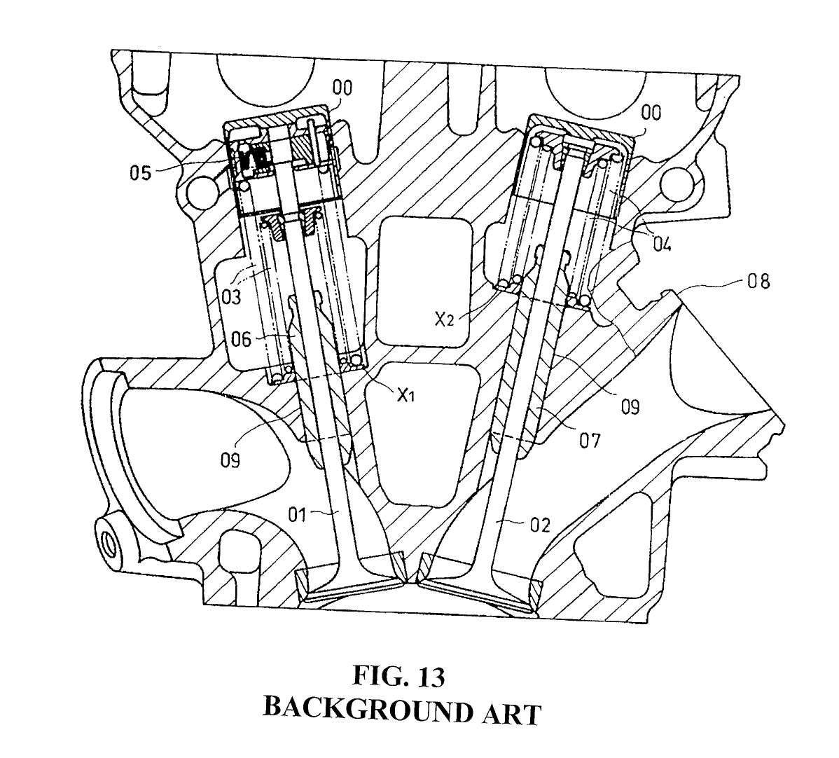

One embodiment of the invention shown in FIGS. 1 to 12 will be described below. An OHC four-stroke internal combustion engine 1 mounted on a motorcycle not shown is a fore and after V-type internal combustion engine in which a crankshaft (not shown) is directed in a direction of the body width and a cylinder on the front side of a vehicle body and a cylinder on the rear side of the vehicle body make a right included angle before and behind as shown in FIG. 1. The body of the OHC four-stroke internal combustion engine 1 is composed of a cylinder block 2, a crankcase 3 integrated with the cylinder block 2 on the lower surface of the cylinder block 2, a pair of two cylinder heads 4 integrated with the respective head end of a cylinder bank on the front side of the vehicle body and a cylinder bank on the rear side of the vehicle body in the cylinder block 2 and a pair of two head covers 5 that, respectively, cover the heads of the cylinder heads 4.

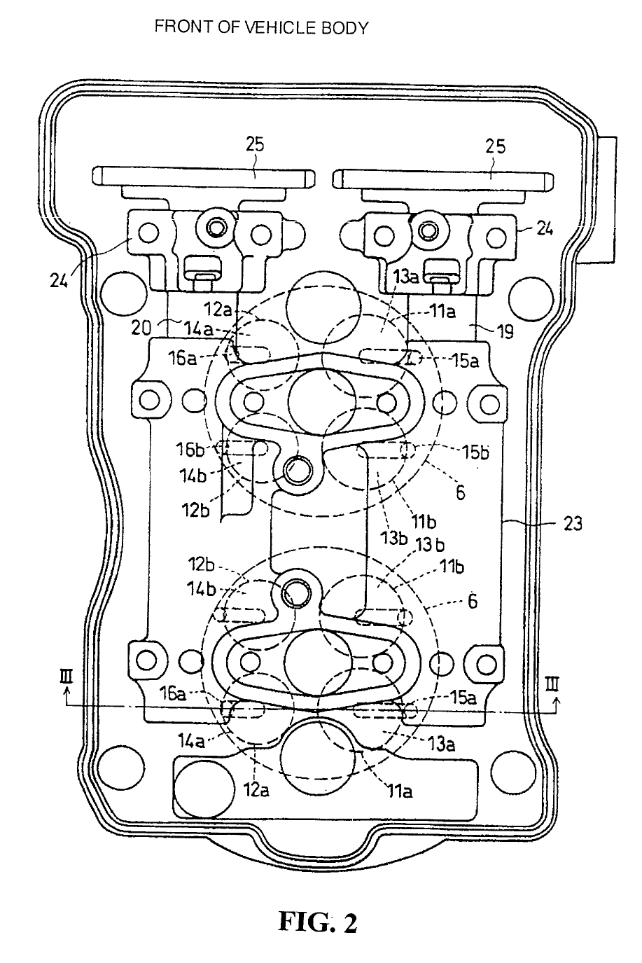

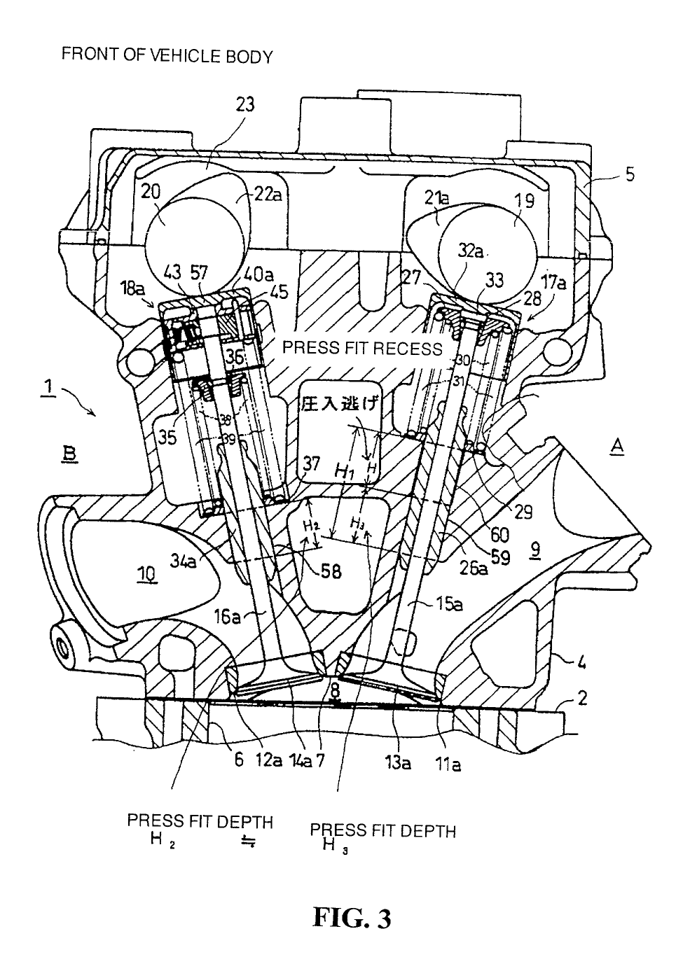

The cylinder blocks 2 are installed on the front side of the vehicle body and on the rear side of the vehicle body and in each of which two cylinder holes 6 are arranged in the direction of the body width as shown in FIG. 2 (only the cylinder block on the front side of the vehicle body out of the cylinder blocks on the front side and the rear side is shown) form the four-cylinder OHC four-stroke internal combustion engine 1. A pent roof type concave portion 7 is respectively formed in a location corresponding to the cylinder hole 6 on the lower surface of each cylinder head 4 located on the front side and on the rear side of the vehicle body as shown in FIGS. 3 to 5 and a combustion chamber 8 is formed by a piston (not shown) fitted into the cylinder hole 6, the cylinder hole 6 and the concave portion 7.

Further, in each cylinder bank on the front side and on the rear side of the vehicle body of the V-type four-cylinder OHC four-stroke internal combustion engine 1, an intake system (not shown) including a carburetor and an intake chamber is arranged on the side of a cylinder included angle (on the side in contact with fore and after V-type space A shown in FIG. 1, that is, the space A between the cylinder bank on the front side of the vehicle body and the cylinder bank on the rear side of the vehicle body). An exhaust pipe, not shown, is connected outside each cylinder bank on the front side and on the rear side of the vehicle body (the outside B of the fore and after V-type space A).

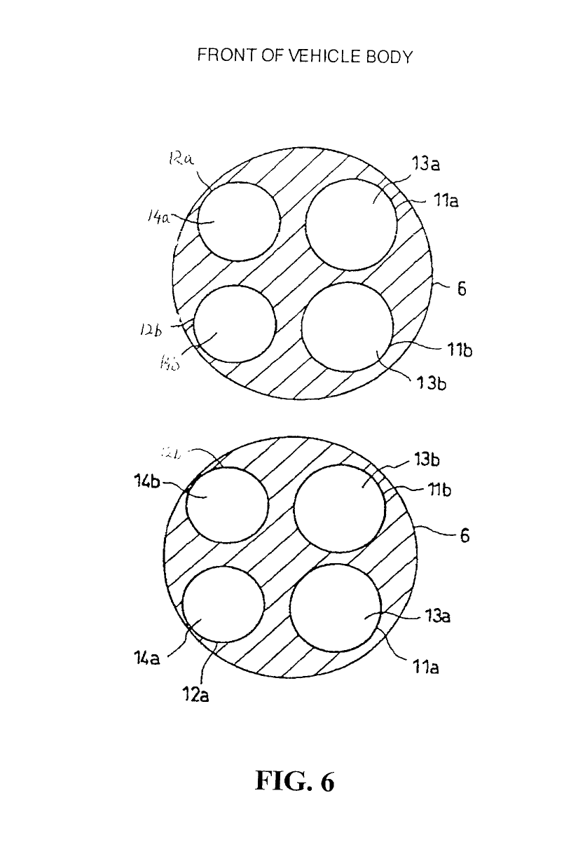

Further, as shown in FIGS. 3 to 5, on the rear side of the vehicle body of the cylinder head 4 on the front side of the vehicle body, one intake passage is formed on the upstream side connected to the intake system is branched into two intake passages on the downstream side of the intake and an inlet port 9 open to the combustion chamber 8 in two locations. On the front side of the vehicle body of the cylinder head 4 on the front side of the vehicle body, two exhaust passages on the upstream side that open to the combustion chamber 8 in two locations are integrated in one exhaust passage on the downstream side of the exhaust. An exhaust port 10 is connected to the exhaust pipe, not shown. As shown in FIGS. 2 and 6, intake poppet valves 13a and 13b and exhaust poppet valves 14a and 14b that respectively seal two inlet openings 11a and 11b and two exhaust openings 12a and 12b so that the valves can be opened or closed are provided on the cylinder head 4.

An inlet port and an exhaust port that are reverse in fore and after positions to the inlet port 9 and the exhaust port 10 in the cylinder head 4 on the front side of the vehicle body are also formed in the cylinder head 4 on the rear side of the vehicle body. That is, on the front side of the vehicle body of the cylinder head 4 on the rear side of the vehicle body, the inlet port (not shown) is formed in the same shape as that of the inlet port 9 on the rear side of the vehicle body of the cylinder head 4 on the front side of the vehicle body and on the rear side of the vehicle body of the cylinder head 4 on the rear side of the vehicle body. The exhaust port (not shown) is formed in the same shape as that of the exhaust port 10 on the front side of the vehicle body of the cylinder head 4 on the front side of the vehicle body.

Furthermore, as shown in FIGS. 2 and 6, the intake poppet valve 13a is always opened or closed to which a valve lifter 17 without a valve pause mechanism shown in FIGS. 3 to 5 attached thereto and is provided to the inlet opening 11a located on the outside of the vehicle body in each cylinder hole 6. The exhaust poppet valve 14a the opening or the closing of which can be paused and to which a valve lifter 18 with the valve pause mechanism shown in FIGS. 3 to 5 is attached is provided to the exhaust opening 12a located on the outside of the vehicle body in each cylinder hole 6.

The intake poppet valve 13b to which the valve lifter 18 with the valve pause mechanism that is attached is provided to the inlet opening 11b located on the inside of the vehicle body in each cylinder hole 6 reversely to the inlet opening 11a on the outside of the vehicle body. The valve lifter 17 without the valve pause mechanism is attached to the exhaust opening 12b located on the inside of the vehicle body in each cylinder hole 6 reversely to the exhaust opening 12a on the outside of the vehicle body (not shown in the longitudinal sectional view).

Only the intake poppet valve 13a that is provided to the inlet opening 1a on the outside of the vehicle body in the cylinder head 4 on the front side of the vehicle body and provided with the valve lifter 17 without the valve pause mechanism and the exhaust poppet valve 14a provided to the exhaust opening 12a and provided with the valve lifter 18 with the valve pause mechanism will be described below.

An inlet camshaft 19 is arranged over an extension of a stem 15a of the intake poppet valve 13a. An exhaust camshaft 20 is arranged over an extension of a stem 16a of the exhaust poppet valve 14a. The inlet camshaft 19 and the exhaust camshaft 20 are attached to the cylinder head 4, respectively, by a camshaft holder 23 located in the center in the direction of the body width and a camshaft holder 24 located on the right side in the direction of the body width so that the respective camshafts can be rotated as shown in FIG. 2. An inlet cam 21a of the inlet camshaft 19 and an exhaust cam 22a of the exhaust camshaft 20 are provided with every cylinder hole 6 touched to each top face of the valve lifter 17a without the valve pause mechanism of the intake poppet valve 13a and the valve lifter 18a with the valve pause mechanism of the exhaust poppet valve 14a. A driven sprocket 25 is respectively integrated with the inlet camshaft 19 and the exhaust camshaft 20 at the right end of the vehicle body. A continuous chain, not shown, is positioned between a drive sprocket (not shown) integrated with a crankshaft not shown and the driven sprocket 25. When the OHC four-stroke internal combustion engine 1 is operated, an inlet cam 21 and an exhaust cam 22 are rotated at a speed equivalent to one-half of the rotational speed of the crankshaft and in the same direction.

As shown in FIGS. 3 to 5, each contact surface of the cylinder head 4 and the camshaft holder 23 or 24 is located in a plane tying the center of the inlet camshaft 19 and the center of the exhaust camshaft 20. Each contact surface of the cylinder head 4 and the camshaft holder 23 or 24 is made to be parallel to each contact surface of the cylinder block 2 and the cylinder head 4. Therefore, the distance from the top wall 32 of the valve lifter 17 without the valve pause mechanism to the inlet opening 11 and distance from the top wall 40 of the valve lifter 18 with the valve pause mechanism to the exhaust opening 12 are made substantially equal.

However, as the valve pause mechanism 41 is not provided to the valve lifter 17a without the valve pause mechanism attached to the stem 15a of the intake poppet valve 13a, a retainer 27 is integrally fitted to the top of the stem 15a via a cotter 28 adjacently under the lower surface of the top wall 32a of the valve lifter 17a without the valve pause mechanism. In the meantime, as the valve pause mechanism 41 is provided to the valve lifter 18a with the valve pause mechanism to attached to the stem 16a of the exhaust poppet valve 14a. a retainer 35 is integrated fitted via a cotter 36 further under the valve pause mechanism 41 under the top wall 40 of the valve lifter 18a with the valve pause mechanism. The length of valve lifter springs 30 and 31 for pressing the intake poppet valve 13 and the valve lifter 17a without the valve pause mechanism upward and each length of a valve lifter spring 38 for pressing the exhaust poppet valve 14 upward and a valve lifter spring 39 for pressing the valve lifter 18a with the valve pause mechanism upward are set to be substantially identical in length so as to give a substantially identical spring load and a substantially identical characteristic.

Therefore, as shown in FIG. 3, a valve guide cylinder 26a that guides and supports the stem 15a of the intake poppet valve 13a so that the stem can slide is longer than a valve guide cylinder 34a that guides and supports the stem 16a of the exhaust poppet valve 14a so that the stem can slide. In addition, a valve spring retainer 29 is provided for supporting each lower end of the valve lifter springs 30 and 31 of the intake poppet valve 13a and is located on the upside of a valve spring retainer 37 for supporting each lower end of the valve lifter springs 38 and 39 of the exhaust poppet valve 14a. As a result, the depth in which the valve guide cylinder 26a is fitted into the cylinder head 4 is deeper than the depth in which the valve guide cylinder 34a is fitted into the cylinder head 4.

The cylinder head 4 is cast so that a fitting hole 58 that has a smaller diameter than the outside diameter of the valve guide cylinder 34a is formed in a portion into which the valve guide cylinder 34a is fitted in the cylinder head 4. A lower fitting hole 59 having a smaller diameter than the outside diameter of the valve guide cylinder 26a and having the same depth as the depth H₂ of the fitting hole 58 and an upper idle fitting hole 60 having a larger diameter than the outside diameter of the valve guide cylinder 26a are formed in a portion into which the valve guide cylinder 26a is fitted in the cylinder head 4. The cutting work is reduced with respect to the respective outside diameters of the valve guide cylinders 34a and 26a by an amount of press fitting that is applied to form the whole fitting hole 58 and the lower fitting hole 59 in the cylinder head 4. Over the fitting hole 59, if necessary, the cutting work is applied to an extent that the peripheral surface of the valve guide cylinder 26a is not touched to the upper idle fitting hole 60 at all.

That is, the depth of the fitting hole 58 of the valve guide cylinder 34a is set to H₂. The depth of the fitting part of the valve guide cylinder 26a is set to H₁ and the depth of the idle fitting hole 60 is set to H (=H₁−H₃) acquired by subtracting H₃ substantially equal to the depth H₂ of the fitting hole 58 from the depth H₁ of the fitting part.

The inside diameter of the idle fitting hole 60 is adjusted in a range from a minimum value of a diameter in which no interference with the valve guide 26a caused by the eccentricity of the fitting hole 59 occurs to a maximum value of the diameter in which an area where no bucking occurs in the valve spring retainer 29 can be secured. Therefore, if the above-mentioned condition is met, the idle fitting hole 60 can also be formed by casting out in addition to cutting work.

Also, the valve guide cylinder 34a and the valve guide cylinder 26a are respectively press-fitted into the fitting hole 58 and the lower fitting hole 59 in the cylinder head 4 with uniform press-in force in a predetermined time.

Further, the valve spring retainers 29 and 37 are fitted to the respective upper exposed parts of the valve guide cylinder 26a and the valve guide cylinder 34a, the two inside and outside valve lifter springs 30 and 31 are fitted in parallel between the retainer 27 and the valve spring retainer 29 and the two inside and outside valve lifter springs 38, 39 are fitted in parallel between the retainer 35 or the valve pause mechanism 41 and the valve spring retainer 37. The intake poppet valve 13 and the exhaust poppet valve 14 are pressed in a direction in which the inlet opening 11a of the inlet port 9 and the exhaust opening 12a of the exhaust port 10 are sealed by the spring of the valve lifter springs 30, 31 and the valve lifter springs 38, 39. The top wall 32a of the valve lifter 17a without the valve pause mechanism and the top wall 40a of the valve lifter 18a with the valve pause mechanism are pressed in a direction in which the valve lifters are respectively touched to the inlet cam 21a and the exhaust cam 22a.

A shim 33 is fitted between the top wall 32a of the valve lifter 17a without the valve pause mechanism and the top end of the stem 15a. A thicker part 57 is slightly thicker than the peripheral part for functioning as a shim that is formed in the center of the top wall 40a of the valve lifter 18a with the valve pause mechanism. The thicker shim part 57 is formed in various thickness and a few types of valve lifters 18a with the valve pause mechanism are prepared.

Next, the valve pause mechanism 41 in the valve lifter 18 with the valve pause mechanism will be described.

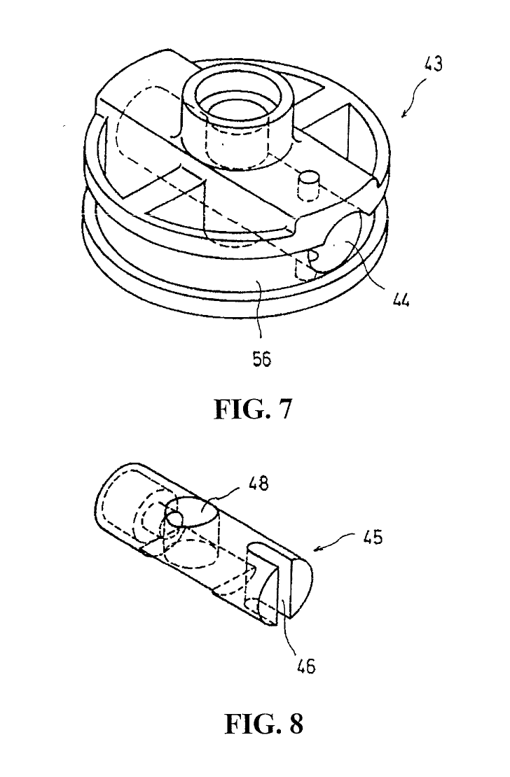

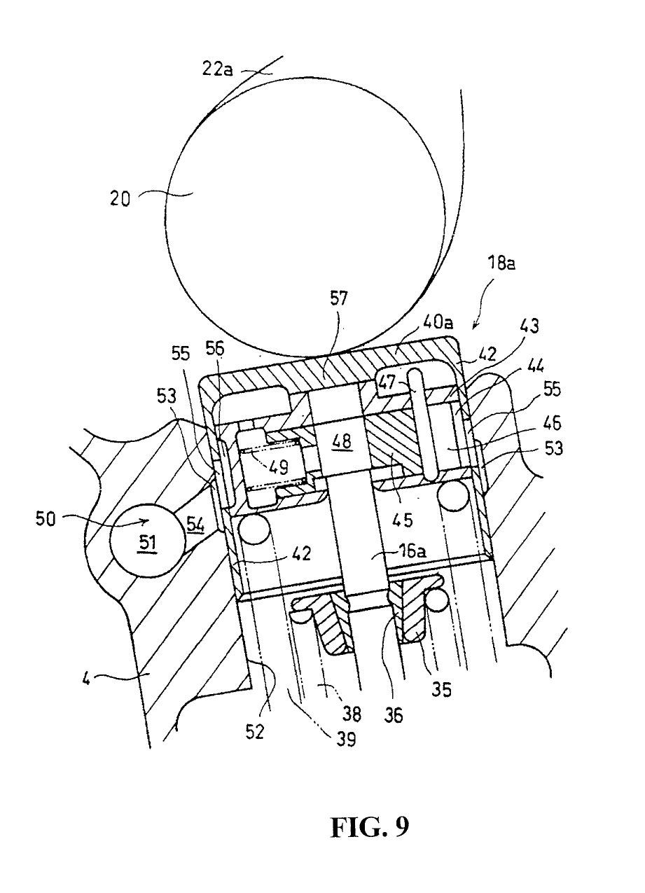

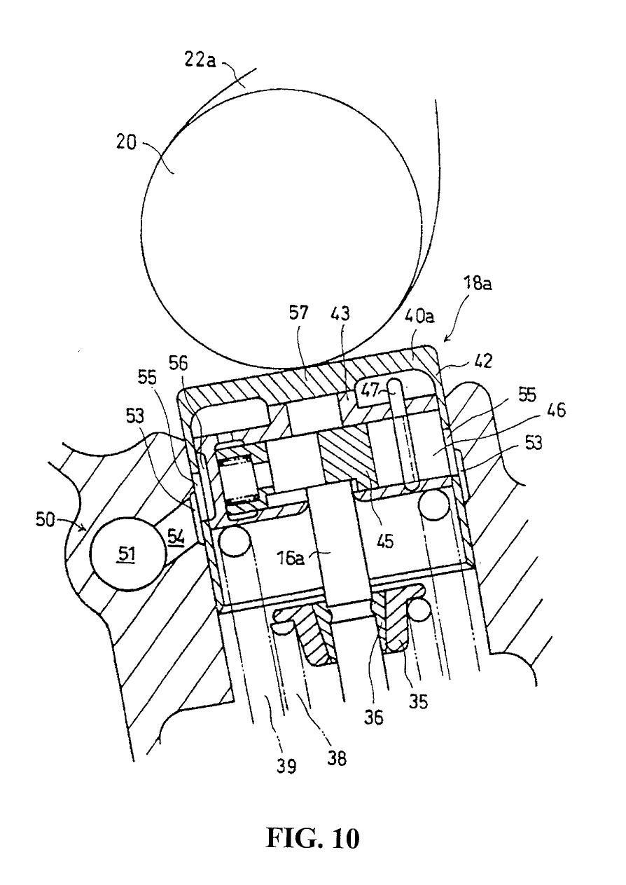

As shown in FIGS. 9 and 10, the valve pause mechanism 41 is formed by a slide pin holder 43 shown in FIG. 7 fitted to a cylindrical peripheral wall 42 of the valve lifter 18a with the valve pause mechanism so that the slide pin holder can be moved in a direction (a vertical direction) in which the valve lifter 18a with the valve pause mechanism is slidably mounted. A slide pin 45 shown in FIG. 8 is fitted into a pin hole 44 of the slide pin holder 43 so that the slide pin can slide to fit the valve pause mechanism to the stem 16a of the exhaust poppet valve 14a so that the slide pin can be detached. A guide pin 47 pierces the slide pin holder 43 and is fitted into a guide groove 46 formed at one end of the slide pin 45. A pin spring 49 is fitted to the other end of the slide pin 45 and to the bottom of the pin hole 44 of the slide pin holder 43 and presses the bottom of the guide groove 46 of the slide pin 45 in a direction in which the bottom is touched to the guide pin 47. A hydraulic drive unit 50 presses the slide pin 45 towards the pin spring 49 against the spring in a stem through hole 48.

In a state shown in FIG. 9 where no oil pressure is supplied to an oil pressure passage 51 on one end side of the pin hole 44 by the hydraulic drive unit 50 and the bottom of the guide groove 46 of the slide pin 45 is touched to the guide pin 47 by the pin spring 49, the stem through hole 48 is formed in the slide pin 45 in a direction in which the stem 16a of the exhaust poppet valve 14a extends and the stem 16a of the exhaust poppet valve 14a can freely slide in the stem through hole 48 of the slide pin 45.

In the hydraulic drive unit 50, as shown in FIGS. 9 and 10, the pressure oil passage 51 connected to a discharge port of a hydraulic pump (not shown) is provided in the OHC four-stroke internal combustion engine 1 via a control valve (not shown) that is formed in the cylinder head 4. A peripheral concave groove 53 is formed in a lifter guide hole 52 of the valve lifter 18 with the valve pause mechanism provided relative to the cylinder head 4, and the pressure oil passage 51 and the peripheral concave groove 53 in communication via a connecting hole 54.

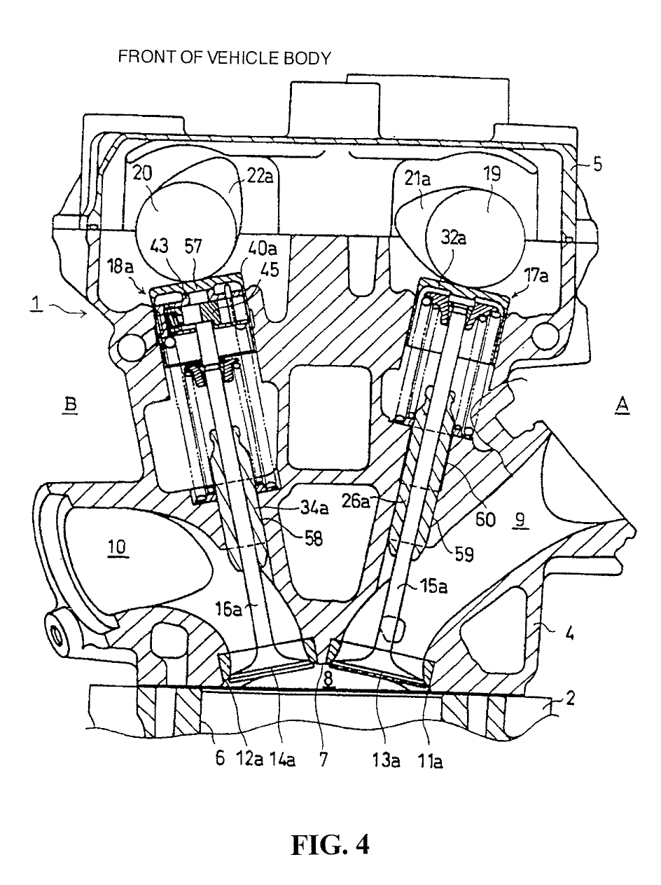

Further, a side hole 55 that is in communication with the peripheral concave groove 53 of the lifter guide hole 52 is formed in the cylindrical peripheral wall 42 of the valve lifter 18 with the valve pause mechanism even if the valve lifter 18a with the valve pause mechanism is located in any location when the valve lifter 18a with the valve pause mechanism is vertically moved by the exhaust cam 22a. As shown in FIG. 7, the peripheral concave groove 56 in communication with the side hole 55 is formed on the peripheral surface of the slide pin holder 43. The peripheral concave groove 56 communicates with an opening of the pin hole 44. When oil pressure is supplied to the oil pressure passage 51, oil pressure is supplied to the opening of the pin hole 44 from the oil pressure passage 51 via the connecting hole 54, the peripheral concave groove 53, the side hole 55 and the peripheral concave groove 56. The slide pin 45 is moved toward the pin spring 49 against the spring force of the pin spring 49 with the pressure of the pressure oil (see FIGS. 4, 5 and 10). The stem 16a of the exhaust poppet valve 14a is fitted to the slide pin 45. The valve lifter 18b with the valve pause mechanism is provided relative to the inlet port 11b located on the inside of the vehicle body reversely to the inlet port 11a on the outside of the vehicle body. The valve lifter 17b without the valve pause mechanism is provided relative to the exhaust port 12b located on the inside of the vehicle body.

In the embodiment shown in FIGS. 1 to 12, as described above, as the fitting hole 59 into which the longer valve guide cylinder 26a is press-fitted and the fitting hole 58 into which the shorter valve guide cylinder 34a is press-fitted are substantially equal in press fit thickness and press fit depth, the valve guide cylinders 26a and 34a are respectively press-fitted into the fitting holes 59 and 58 of the cylinder head 4 on the same press fitting conditions such as press fitting force and press fitting time. Therefore, the press fitting work and the control of the valve guide cylinders 26a and 34a are greatly simplified and the productivity is enhanced. In addition, the press fit quality is satisfactorily stably.

A similar effect is also produced with regard to the press fitting of a valve guide cylinder 26b for guiding and supporting a stem 15b of another intake poppet valve 13b so that the stem can slide and the press fitting of a valve guide cylinder 34b for guiding and supporting a stem 16b of another exhaust poppet valve 14b so that the stem can slide.

In a state wherein the OHC four-stroke internal combustion engine 1 is operated at a low speed or at a low load and no oil pressure is supplied to the oil pressure passage 51, the slide pin 45 is pressed and moved in a direction in which the slide pin is separated from the pin spring 49 by the spring force of the pin spring 49. As shown in FIGS. 3 and 9, the bottom of the guide groove 46 is fitted to the guide pin 47 with the stem through hole 48 located over the stem 15b or 16a.

In the above-mentioned operational state at low speed or at a low load, as the top of the stem 15b or 16a of the intake poppet valve 13b or the exhaust poppet valve 14a can relatively freely slide through the stem through hole 48 of the slide pin 45, the intake poppet valve 13b or the exhaust poppet valve 14a is held a closed state even if the valve lifter 18a or 18b with the valve pause mechanism is vertically lifted or lowered by the inlet cam 21 or the exhaust cam 22 and is set to a valve pause state.

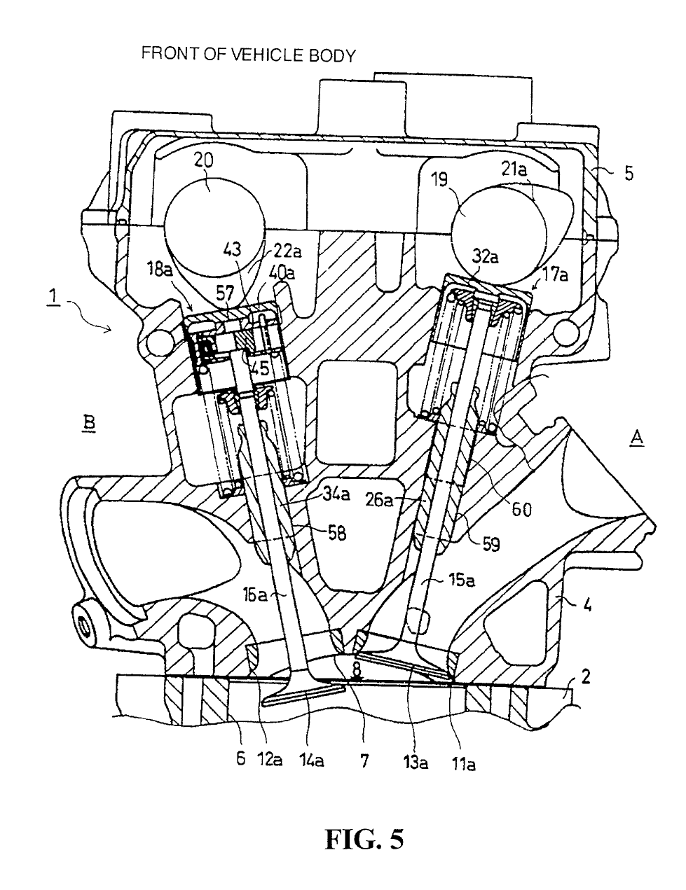

However, when the OHC four-stroke internal combustion engine 1 is operated at high speed or at a high load and oil pressure is supplied to the oil pressure passage 51, oil pressure is supplied into the pin hole 44 from the oil pressure passage 51 via the connecting hole 54, the peripheral concave groove 53, the side hole 55 and the peripheral concave groove 56 and the slide pin 45 is driven in a direction in which the slide pin approaches the pin spring 49 against the spring force of the pin spring 49 by the pressure of pressure oil in the opening of the pin hole 44. As shown in FIGS. 4, 5 and 10, the respective stems 15b and 16a of the intake poppet valve 13b and the exhaust poppet valve 14a are fitted into each bottom cutout 45a of each slide pin 45. As shown in FIG. 5, the intake poppet valve 13b and the exhaust poppet valve 14a are opened and closed.

As the valve pause mechanism 41 is respectively built in the valve lifters 18a and 18b with the valve pause mechanism, the height is apt to be large. However, as no shim 33 is provided to the valve lifters 18a and 18b with the valve pause mechanism, the height of the valve lifters 18a and 18b with the valve pause mechanism is reduced by a quantity and even if a valve included angle of the intake poppet valve 13 and the exhaust poppet valve 14 is reduced to reduce the combustion chamber 8 and increase compression ratio, the height of the cylinder head 4 is prevented from being increased and the large-sizing of the OHC four-stroke internal combustion engine 1 is avoided.

Further, as no shim 33 is provided to the valve lifters 18a and 18b with the valve pause mechanism, the equivalent weight of the intake poppet valve 13b and the exhaust poppet valve 14a decreases, the spring load of the valve spring 31 is reduced and power loss for opening or closing the intake poppet valve 13b and the exhaust poppet valve 14a is reduced.

Furthermore, as work for attaching the shim 33 to the valve lifters 18a and 18b with the valve pause mechanism is not required, assembling man-hours are reduced and productivity is enhanced.

In addition, as the valve lifters 17a and 17b without the valve pause mechanism have no valve pause mechanism 41, the height of the valve lifters 17a and 17b without the valve pause mechanism can be equalized to that of the valve lifters 18a and 18b with the valve pause mechanism even if the shim 33 is provided. Only one type of valve guide cylinder 34 is prepared for the valve lifters 17a and 17b without the valve pause mechanism. Thus, the stock management of the valve lifters 17a and 17b without the valve pause mechanism is simplified and the cost can be reduced.

In a state wherein the exhaust poppet valve 14a and the intake poppet valve 13b are operated at a low speed or at a low load at which the valve is paused by the valve lifters 18a and 18b with the valve pause mechanism, as the intake poppet valve 13a and the exhaust poppet valve 14b, respectively, are always opened or closed and are diagonally located as shown in FIGS. 2 and 6, a swirl is generated in an air-fuel mixture in the combustion chamber 8. Thus, ignition is securely executed, the generation of unburned gas is inhibited and the fuel economy is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cylinder head of a four-stroke internal combustion engine in which a plurality of valve guides respectively guide and support an intake poppet valve and an exhaust poppet valve for sliding in an opened or closed direction with a substantially uniform thickness in the longitudinal direction of each valve guide and a depth in which at least one valve guide of the plurality of valve guides is fitted in the cylinder head with a different depth relative to the other valve guide fitted in the cylinder head, wherein:
an idle fitting hole includes a depth determined by subtracting a depth substantially equal to the depth of a shallower fitted part from a depth of a deeper fitted part and thicker than the valve guide is formed from the end face of the fitted part on the side of a valve spring toward an inlet port or an exhaust port in the cylinder head.

2. The cylinder head of a four-stroke internal combustion engine according to claim 1, wherein the depth of insertion of a valve guide in the idle fitting hole is a predetermined depth that is equal to the depth of insertion of a second valve guide into a second idle fitting hole.

3. The cylinder head of a four-stroke internal combustion engine according to claim 1, wherein the idle fitting hole includes a first section that is substantially equal in depth to the depth of insertion of a valve guide in the deeper fitted part and a second section that accommodates the valve guide with a diameter that is substantially equal to the diameter of the valve guide.

4. The cylinder head of a four-stroke internal combustion engine according to claim 1, and further including biasing means for individually biasing the inlet poppet valve and the exhaust poppet valve to a closed positioned.

5. The cylinder head of a four-stroke internal combustion engine according to claim 3, wherein the second section for accommodating the valve guide is a diameter for providing no interference with the valve guide.

6. The cylinder head of a four-stroke internal combustion engine according to claim 3, wherein the second section for accommodating the valve guide is a diameter where no bucking occurs relative to the valve guide.

7. A cylinder head of a four-stroke internal combustion engine, wherein:
a valve lifter is operatively connected to an inlet cam or an exhaust cam for pressing down a top of an intake poppet valve or an exhaust poppet valve in an opened direction, said valve lifter is operatively attached to the intake poppet valve or the exhaust poppet valve;
the valve lifter of the intake poppet valve or the exhaust poppet valve is fitted into and supported by a shallower valve guide in a depth of a fitted part that is provided with a valve pause mechanism for pausing the opening or closing motion of the intake or exhaust poppet valve by the inlet cam or the exhaust cam; and
the valve lifter of the intake poppet valve or the exhaust poppet valve fitted into and supported by a deeper valve guide in a depth of the fitted part is not provided with the valve pause mechanism.

8. The cylinder head of a four-stroke internal combustion engine according to claim 7, wherein the depth of insertion of the shallower valve guide in the fitted part is a predetermined depth that is equal to the depth of insertion of the deeper valve guide in the fitted part.

9. The cylinder head of a four-stroke internal combustion engine according to claim 7, wherein a fitting hole of the deeper valve guide includes a first section that is substantially equal in depth to a depth of insertion of the shallower valve guide in the fitted part and a second section that accommodates the valve guide with a diameter that is substantially equal to the diameter of the valve guide.

10. The cylinder head of a four-stroke internal combustion engine according to claim 7, and further including biasing means for individually biasing the inlet poppet valve and the exhaust poppet valve to a closed positioned.

11. The cylinder head of a four-stroke internal combustion engine according to claim 9, wherein the second section for accommodating the valve guide is a diameter for providing no interference with the valve guide.

12. The cylinder head of a four-stroke internal combustion engine according to claim 9, wherein the second section for accommodating the valve guide is a diameter where no bucking occurs relative to the valve guide.

13. A cylinder head of an internal combustion engine comprising:
at least one intake poppet valve;
at lease one exhaust poppet valve;
a first valve guide for guiding and supporting the intake poppet valve for sliding in an opened or closed direction;
a second valve guide for guiding and supporting the exhaust poppet valve for sliding in an opened or closed direction;
said first valve guide having a substantially uniform thickness in the longitudinal direction and a first predetermined depth;
said second valve guide having a substantially uniform thickness in the longitudinal direction and a second predetermined depth;
a first fitting hole formed in said cylinder head and having a depth corresponding to the first predetermined depth; and
a second fitting hole formed in said cylinder head and having a depth determined by subtracting a depth substantially equal to the first predetermined depth of the first fitting hole from a depth of the second fitting hole with the second valve guide being positioned within said second fitting hole with a depth of fitting substantially equal to a depth of fitting of the first valve guide positioned within the first fitting hole.

14. The cylinder head for an internal combustion engine according to claim 13, wherein the second fitting hole includes a first section that is substantially equal in depth to the depth of insertion of the first valve guide in the first fitting hole and a second section that accommodates the second valve guide with a diameter that is substantially equal to the diameter of the second valve guide.

15. The cylinder head for an internal combustion engine according to claim 13, and further including biasing means for individually biasing the inlet poppet valve and the exhaust poppet valve to a closed positioned.

16. The cylinder head for an internal combustion engine according to claim 14, wherein the second section for accommodating the second valve guide is a diameter for providing no interference with the second valve guide.

17. The cylinder head for an internal combustion engine according to claim 14, wherein the second section for accommodating the second valve guide is a diameter where no bucking occurs relative to the second valve guide.

18. A cylinder head of an internal combustion engine comprising:
at least one intake poppet valve;
at lease one exhaust poppet valve;
a first valve guide for guiding and supporting the intake poppet valve for sliding in an opened or closed direction;
a second valve guide for guiding and supporting the exhaust poppet valve for sliding in an opened or closed direction;
said first valve guide having a substantially uniform thickness in the longitudinal direction and a first predetermined depth;
said second valve guide having a substantially uniform thickness in the longitudinal direction and a second predetermined depth;
a second fitting hole formed in said cylinder head and having a depth corresponding to the second predetermined depth; and
a first fitting hole formed in said cylinder head and having a depth determined by subtracting a depth substantially equal to the second predetermined depth of the second fitting hole from a depth of the first fitting hole with the first valve guide being positioned within said first fitting hole with a depth of fitting substantially equal to a depth of fitting of the second valve guide positioned within the second fitting hole.

19. The cylinder head for an internal combustion engine according to claim 18, wherein the first fitting hole includes a first section that is substantially equal in depth to the depth of insertion of the second valve guide in the second fitting hole and a second section that accommodates the first valve guide with a diameter that is substantially equal to the diameter of the first valve guide.

20. The cylinder head for an internal combustion engine according to claim 18, and further including biasing means for individually biasing the inlet poppet valve and the exhaust poppet valve to a closed positioned.

21. The cylinder head for an internal combustion engine according to claim 19, wherein the second section for accommodating the first valve guide is a diameter for providing no interference with the first valve guide.

22. The cylinder head for an internal combustion engine according to claim 18, wherein the second section for accommodating the first valve guide is a diameter where no bucking occurs relative to the first valve guide.
